(19) United States
(12) Patent Application Publication
(10) Pub. No.: US 2009/0277484 A1
(43) Pub. Date: Nov. 12, 2009

(54) WATER-CONDUCTING DOMESTIC APPLIANCE AND PLASTIC PART THEREFOR

(75) Inventors: Helmut Jerg, Giengen (DE); Thomas Wachinger, Hohenzell (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgerate GmbH, Munich (DE)

(21) Appl. No.: 12/431,286

(22) Filed: Apr. 28, 2009

(30) Foreign Application Priority Data
May 6, 2008 (DE) 10 2008 022 219.4

(51) Int. Cl. B08B 3/10

(52) U.S. Cl. 134/56 D; 134/115 R

(57) ABSTRACT

A domestic appliance includes a washing compartment for accommodating items to be washed, and one of a plastic inner part and a plastic outer part on the washing compartment including a plastic that dispenses fragrance.

### BACKGROUND OF THE INVENTION

The present invention relates to a water-conducting domestic appliance, in particular a dishwasher including a washing compartment for accommodating items to be washed, with one or several plastic inner parts and/or plastic outer parts being provided in and/or on the washing compartment respectively.

With a domestic appliance, in particular with dishwashers of the prior art, an unpleasant smell is frequently noticed when the washing compartment doors are opened, which inter alia originates from the dirty items to be washed. Some attempts have thus already been made to hide unpleasant smells when opening the container doors of a water-conducting domestic appliance and/or to design the interior of the water-conducting domestic appliance to be more pleasantly smelling. One of the solutions consists in starting a short rinsing program after a certain holding time. This software solution is to ensure that the dirt on the items to be washed is roughly rinsed off in order to prevent smells from developing. The disadvantage here is that electricity and water are needed and smells can already develop even before reaching the predetermined holding time.

It is also known for accessories, which are to hide the unpleasant smells using more pleasant fragrances, to be introduced into the container. These air fresheners consist of baskets containing fragrance granules for instance, which are positioned in or suspended on the dishes holder for instance. The disadvantage here is that these air fresheners are used up relatively quickly and have to be replaced. Furthermore, they reduce the storage capacity of the washing compartment.

A suggestion was already made as a further measure to provide odor-eradicating facilities in the dishwasher. For example, air ionizers may cause air in the washing compartment to be neutralized. The disadvantage here however is that odor-eradicating facilities of this type are very expensive.

### BRIEF SUMMARY OF THE INVENTION

An object of the present invention is to prevent the afore-cited disadvantages and, using simple measures, to design the interior of the compartment of a water-conducting domestic appliance to be pleasant smelling.

According to the invention, this object is achieved with a water-conducting domestic appliance of the type cited in the introduction such that the plastic inner parts and/or plastic outer parts are partially or wholly produced from a fragrance-dispensing plastic.

An inventive water-conducting domestic appliance has a washing compartment for accommodating items to be washed. Plastic inner parts are arranged in the interior of the washing compartment, these being used for instance to accommodate and/or clean the items to be washed or to seal the washing compartment. A corresponding water-conducting domestic appliance is in particular a dishwasher, but may however also be a washing machine or another water-conducting domestic appliance for instance, in which the interior of the washing compartment is to be designed to be pleasant smelling. In accordance with the invention, the plastic inner parts or parts thereof, which are arranged in the interior of the washing compartment, are manufactured from a fragrance-dispensing plastic. In accordance with the invention, the plastic parts made of fragrance-dispensing plastic allow unpleasant smells in the washing compartment to be hidden by means of releasing a fragrance and essentially cause the fragrance of the plastic part to pass into the washing compartment when the washing compartment is opened. Other supply lines or other parts which are connected to the washing compartment in terms of smell are to be understood as the interior of the washing container, the parts being able to guide the released fragrance into the immediate interior of the washing compartment. In addition to or irrespective of the one or several inner components in the washing compartment, provision can also be made in accordance with the invention for one or several plastic outer parts on the washing compartment, which are produced partially or wholly from a fragrance-dispensing plastic. In particular, if these fragrance-dispensing plastic outer parts are arranged in the region of the door opening of the rinsing compartment, smells which flow out of the interior of the washing compartment when the door is opened can be neutralized or hidden.

Fragrance-dispensing plastics are also advantageously able to release the fragrance over a long period of time, in some cases over several years or decades. They can thus generally be used over the entire service life of the domestic appliance and do not need to be replaced in order to renew the fragrance.

Another advantage of these fragrance-dispensing plastic parts may also be that the customer may obtain a positive impression on first contact with the domestic appliance in the sales room of the dealer compared with other domestic appliances as a result of the fragrance developing. The pleasant fragrance of the domestic appliance can also be advertised by means of marketing.

It may be particularly advantageous if no accessories are needed, i.e. if it is not necessary to install additional built-in components in the domestic appliance or to fasten additional parts in the domestic appliance, but instead the already existing inner parts in and/or outer parts on the washing compartment are adequate. Furthermore, no complex technology is needed in order to produce the domestic appliance in accordance with the invention or to provide the fragrance-dispensing plastic.

Both the complete plastic parts as well as only parts of the plastic parts can be manufactured from the fragrance-dispensing plastic.

It may be particularly expedient if the fragrance-dispensing plastic is installed in the washing compartment of the water-conducting domestic appliance as a plastic inner part. An inner component of the washing compartment which is already present in particular comprises the fragrance-dispensing plastic. As a result, an additional component to be installed does not take up unnecessary space in the interior of the washing compartment. The interior of the washing compartment thus remains completely useable for the items to be washed.

If the plastic parts are produced as two K injection molded parts, individual areas of the respective plastic part can be injection molded from a conventional plastic and other areas of the respective plastic part can be injection molded from the fragrance-dispensing plastic. It is herewith possible to use the more expensive fragrance-dispensing plastic only in such a quantity in at least one inner part and/or outer part of the washing compartment, which is sufficient in order to be able to release the desired fragrance into the interior of the washing compartment and/or in particular into an exterior region around the door of the washing compartment.

The plastic part is advantageously in particular a functional part, i.e. a component of the domestic appliance which already exists. No additional, i.e. extra component of the domestic appliance, is thus necessary. Only one component of the domestic appliance, which is needed for the function and efficiency of the domestic appliance and is thus present anyway, is manufactured from the fragrance-dispensing plastic. No additional components and thus incoming costs are thus needed.

If the respective plastic part is arranged in accordance with an advantageous development of the invention in an exchangeable fashion in the interior of the domestic appliance, with a useful life of the domestic appliance, which is consequently longer than the fragrance release of the plastic for instance, the plastic part can be replaced by a plastic part with another fragrance-dispensing plastic for instance. A corresponding plastic interior and/or outer part, which is embodied so as to be exchangeable, also allows a different fragrance to be generated in the interior and or exterior region of the washing compartment. Since the fragrance-dispensing plastic can advantageously release a large number of different fragrances, the individual taste of the user of the domestic appliance is thus taken into consideration.

It is particularly advantageous if the plastic part is arranged in one or several of the following modules for instance: cutlery basket, cutlery grid and/or handle of a cutlery holder, sieving plate and/or filter of a sieving system, supply tube and/or spray arm of a spray system, rack, attachment and/or dish supports of a dish holder, dispensing unit, expansion opening, salt compartment cover, pull-out rails, basket tray. These components and/or modules are all arranged in the interior of the washing compartment or are connected hereto so that the released fragrance reaches the interior. It is essential for the fragrance development of the one or several inner parts in the interior of the washing compartment of the domestic appliance to obliterate the unpleasant smells developing there.

Other components, in particular outer parts of the washing compartment, of the domestic appliance can naturally be advantageously manufactured from the fragrance-dispensing plastic. These exterior components are preferably arranged in the door region of the washing compartment in order to be able to release there a pleasant fragrance, with which unpleasant smells appearing from the interior of the washing compartment when the door is open can be neutralized and hidden. The fragrance-dispensing plastic is preferably arranged in one or several of the following modules or components as an outer part: control panel, one or several control elements of a control panel, doors of the washing compartment, base of the washing compartment, tub floor of the washing compartment, and/or work top of the dishwasher.

The fragrance-dispensing plastic is preferably a polymer, in which a fragrance is encased. The fragrance-dispensing plastic can be processed as a result very easily in the injection molding method to form a plastic part. It is thus possible to produce plastic parts from this polymer, which can be obstructed or stopped inside the washing compartment and/or outside the washing compartment.

The fragrance-dispensing plastic includes a cellulose acetate. Cellulose acetate is particularly well suited to receiving the fragrances and re-releasing them over a long period of time.

If the fragrance-dispensing plastic includes a cellulose acetate propionate or cellulose acetate butyrate, a suitable material can thus be selected depending on the type or site of use of the plastic part, the material maintaining the environmental conditions there.

If the fragrance-dispensing plastic is hygroscopic and responds to air and moisture, it is particularly well suited to continually releasing the fragrance.

The fragrance-dispensing plastic used is advantageously adjusted to the corresponding application in terms of the intensity of its fragrance release. A more intensive fragrance release of the plastic can then be selected for instance if the plastic is used on and/or in a part which is only indirectly connected to the interior of the washing compartment and the fragrance only reaches the interior through tube lines or containers for instance. A more minimal intensity of the fragrance release can then be selected if the plastic is arranged in the vicinity of the washing compartment opening and the corresponding fragrance quickly reaches the operator of the domestic appliance when he/she opens the washing compartment.

It is particularly pleasant and effective if the fragrance-dispensing plastic used dispenses a fruity aroma, in particular a lemony aroma. Many other aromas are however also naturally possible.

If the plastic is arranged in the field of vision of the domestic appliance, it is advantageous for the color of the fragrance-dispensing plastic to be adjusted to the fragrance. A lemony fragrance-dispensing plastic can be designed in yellow for instance, while a plastic smelling of strawberries is manufactured in red.

In accordance with an exemplary embodiment of the invention, an individual plastic part of a domestic appliance, in particular of a dishwasher, is also produced from a fragrance-dispensing plastic. The plastic part is arranged here in a domestic appliance according to the claims, which relate to the domestic appliance.

The invention also relates to a plastic part of a domestic appliance, in particular of a dishwasher, which is characterized in that at least one plastic inner part and/or at least one plastic outer part is partially or wholly manufactured in and/or on the washing compartment from a fragrance-dispensing plastic.

### BRIEF DESCRIPTION OF THE DRAWINGS

The invention and its developments are described in more detail below, with reference to the drawings, in which;

FIG. 1 shows a schematic diagram of a cutlery holder,

FIG. 2 shows a schematic diagram of a sieving system,

FIG. 3 shows a spray system, and

FIG. 4 shows a dish holder

### DETAILED DESCRIPTION OF EXEMPLARY EMBODIMENTS OF THE PRESENT INVENTION

The figures below show individual examples of components of a dishwasher, which are arranged in the interior of the washing compartment of the dishwasher for instance and consist at least partially of plastic. The plastic of the corresponding components is completely or at least partially embodied such that fragrance-dispensing materials are contained therein, which are released during the course of the service life of the dishwasher and hide unpleasant smells developing inside the washing compartment. The exemplary embodiments shown are naturally not all plastic parts, which can be used accordingly in the dishwasher. Other plastic parts (not shown here), which are directly or indirectly connected to the interior, in which the unpleasant smells develop, can be produced from the corresponding fragrance-dispensing plastic. The parts shown here are in particular functional parts which already exist, in particular built-in parts or structural parts, i.e. components of the dishwasher. Fragrance-dispensing plastic parts can alternatively however also be connected to the interior of the washing compartment without any corresponding function and may be produced from a fragrance-dispensing plastic. It is however advantageous to equip existing functional parts accordingly, since an additional introduction of components and thus additional costs can as a result be avoided.

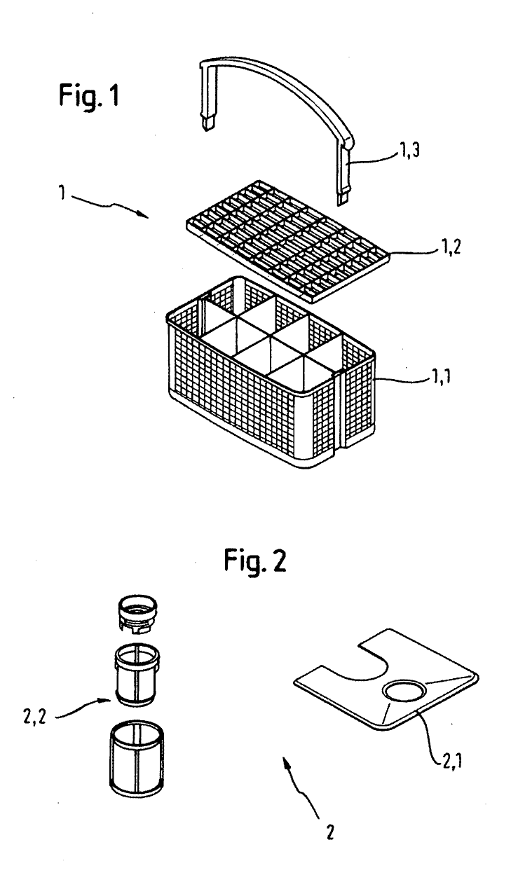

FIG. 1 shows a cutlery holder 1, which consists of a cutlery basket 1.1, a cutlery grid 1.2 and a handle 1.3. All three plastic parts or also only individual parts thereof may be manufactured from a fragrance-dispensing plastic. The cutlery holder 1 is expediently arranged in the direct line of vision of the operator of the dishwasher, so that it can also be used to select the color of the plastic in accordance with the fragrance which is released by the plastic. The cutlery holder 1 or the corresponding parts thereof can be designed in yellow for instance, if a lemony fragrance is released from the plastic.

FIG. 2 shows a sieving system 2. The sieving system 2 consists of a sieving plate 2.1 and filter parts 2.2 with the associated receptacles and seals. The sieving plate 2.1 and the filter 2.2 can partially consist of metal and partially of plastic. If the corresponding plastic parts are manufactured from a fragrance-dispensing material, the fragrance release takes place there, where an intensive bad smell can emerge as a result of the filtered out food residues. It is advantageous at such points to use a plastic which offers a particularly intensive fragrance release.

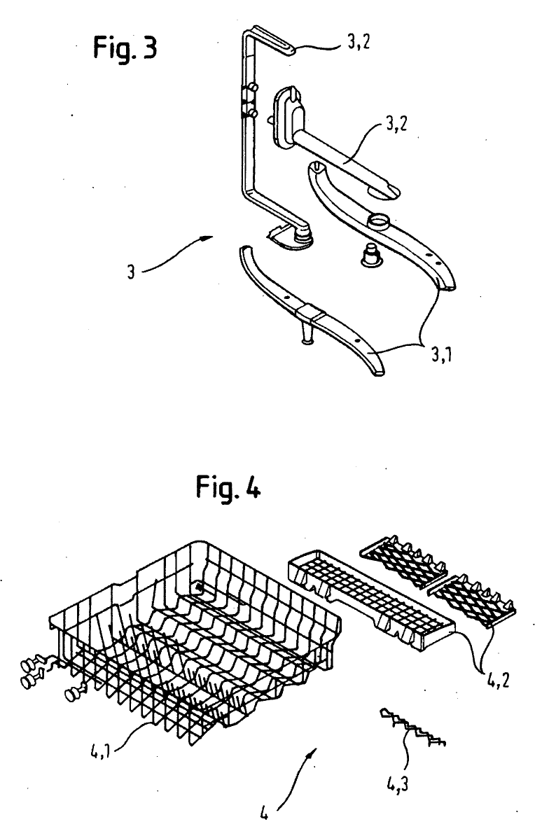

Parts of a spray system 3 are shown in FIG. 3. Some or all of these parts likewise lend themselves to the inventive use of fragrance-dispensing plastic. Both the spray arms 3.1 and also the supply tubes 3.2 and the corresponding connecting parts of the spray system 3 can be produced from the fragrance-dispensing material. Since these parts are relatively large and extend across a significant part of the interior of the washing compartment, an intensive and equal distribution of the fragrance across the entire interior of the washing compartment is expected when using these parts made of a fragrance-dispensing plastic.

FIG. 4 shows a dish holder 4. The dish holder 4 includes a basket 4.1, racks 4.2 and a dish bracket 4.3. If all parts or individual parts hereof are manufactured from the fragrance-dispensing plastic, the fragrance release is reduced in the immediate region of the dishes exhibiting food residues which produce unpleasant smells. A particularly effective fragrance release is achieved here.

The advantageous principle according to the exemplary embodiments in FIGS. 1 to 4 of partially or wholly integrating fragrance-dispensing plastic into one or several inner parts, in particular functional parts, built-in parts, adjusting parts or components of the washing compartment, can generally be transferred to further structural components in or on the washing compartment. Further components, which are suited to the manufacture of fragrance-dispensing plastic, are located in a detergent dispenser, an expansion opening, in the salt compartment cover, in pull-out rails or the molded recess of the basket. Plastic parts made of fragrance-dispensing material can also be manufactured outside the interior of the washing compartment if these parts are connected to the interior of the washing compartment or are arranged in particular in the exterior region of the door of the washing compartment. It is particularly advantageous if the fragrance-dispensing component is only directed inwards into the interior of the washing compartment so that the fragrance release does not leak outwards when the washing compartment is closed in order to avoid a fragrance release of the domestic appliance into the surroundings in the case of a closed washing compartment.

In addition or alternatively, fragrance-dispensing plastic parts can however also be provided in one or several of the exterior modules or components on the washing compartment. Such outer parts are for instance: control panel, one or several control elements, doors of the washing compartment, base of the washing compartment, tub base of the washing compartment and/or work top of the dishwasher.

In particular, if the fragrance-dispensing plastic material is hygroscopic and releases the fragrance by means of the interaction between air and moisture, the inventive principle can also be used in other water-conducting domestic appliances as dishwashers. Washing machines can thus likewise be equipped with inventive plastic parts.

1. A domestic appliance comprising:
a washing compartment for accommodating items to be washed; and
one of a plastic inner part and a plastic outer part on the washing compartment comprising a plastic that dispenses fragrance.

2. The domestic appliance of claim 1, wherein the plastic inner part is in an interior of the washing compartment.

3. The domestic appliance of claim 1, wherein the respective plastic inner part is connected to an interior of the washing compartment.

4. The domestic appliance of claim 1, wherein the plastic inner part forms a part of one of a cutlery basket, cutlery grid, handle of cutlery holder, sieving plate, filter of a sieving system, supply tube, spray arm of a spray system, basket, rack, dish bracket of a dish holder, dispenser, expansion opening, salt compartment cover, pull-out rails, and basket tray.

5. The domestic appliance of claim 1, wherein the plastic is in one of a control panel, a control element of a control panel, a door of the washing compartment, a base of the washing compartment, a base tub of the washing compartment, and a work top of the dishwasher.

6. The domestic appliance of claim 1, the plastic comprises a polymer that encloses a scent.

7. The domestic appliance of claim 1, wherein the plastic comprises a cellulose acetate.

8. The domestic appliance of claim 1, wherein the plastic comprises a cellulose acetate propionate.

9. The domestic appliance of claim 1, wherein the plastic comprises a cellulose acetate butyrate.

10. The domestic appliance of claim 1, wherein the plastic is hygroscopic and reacts to air and moisture.

11. The domestic appliance of claim 1, wherein plastic has an intensity of fragrance release that is adjusted to an application.

12. The domestic appliance of claim 1, wherein the plastic dispenses a citrus fruit aroma.

13. The domestic appliance of claim 1, wherein a color of the plastic is adapted to the fragrance of the plastic.

14. A plastic part for a domestic appliance, that comprises a fragrance-dispensing plastic.
